(19) United States
(12) Patent Application Publication
(10) Pub. No.: US 2018/0063095 A1
(43) Pub. Date: Mar. 1, 2018

(54) DATA ENCIPHERMENT PRIOR TO RECIPIENT SELECTION

(71) Applicant: AtCipher.com Limited, Hong Kong (HK)

(72) Inventors: Jack S. Poon, Hong Kong (HK); Duncan S. Wong, Hong Kong (HK)

(21) Appl. No.: 15/691,387

(22) Filed: Aug. 30, 2017

Related U.S. Application Data
(60) Provisional application No. 62/382,289, filed on Sep. 1, 2016.
(60) Provisional application No. 62/382,300, filed on Sep. 1, 2016.

(51) Int. Cl. H04L 29/06; H04L 9/08

(52) U.S. Cl. CPC H04L 63/0442; H04L 9/0861

(57) ABSTRACT

The present disclosure relates, according to some embodiments, to a system for enciphering data. The system comprises a computing device processor configured for: determining, at a first computing device, key information; enciphering, at the first computing device, data using the key information; and selecting, at the first computing device, a recipient after enciphering the data.

### CROSS-REFERENCE TO RELATED APPLICATIONS

This application claims priority to U.S. Provisional Application No. 62/382,289 filed on Sep. 1, 2016, and U.S. Provisional Application No. 62/382,300 filed on Sep. 1, 2016. The entire contents of the applications listed above are hereby incorporated in their entirety by reference for all purposes. This application is being filed simultaneously with U.S. patent application Ser. No. ______, docket number 10097425-50283598, and titled “Management of Enciphered Data Sharing,” the entire contents of which are hereby incorporated by reference in their entirety for all purposes. Any portion of any of these applications may be combined with any portion of the instant application.

### FIELD OF THE DISCLOSURE

The present disclosure generally relates to encryption methods and systems.

### BACKGROUND OF THE DISCLOSURE

A need exists for an improved data encryption and data sharing method that provides for accessing encrypted data with greater efficiency without compromising security. It is challenging to efficiently and securely share encrypted data with multiple parties under restrictions of time and resources. Accordingly, a need has arisen for an improved data encryption and secure sharing method.

### SUMMARY

This summary is provided to introduce a selection of concepts in a simplified form that are further described in below in the Detailed Description. This summary is not intended to identify key features or essential features of the claimed subject matter, nor is it intended to be used as an aid in determining the scope of the claimed subject matter. Other objects and features will be in part apparent and in part pointed out hereinafter. In some embodiments, a method is provided for enciphering data prior to key setup. The method comprises: A method for generating keys, comprising: determining, at a sending computing device, a public key, the public key associated with the sending computing device or a user associated with the sending computing device; a method for encrypting a secret message, at the sending computing device, before a recipient is known; a method for generating access token: determining, at a sending computing device, an access token associated with a tag and recipient's publicly known unique identity; a method for decrypting a secret message: determining at a receiving computing device, an access associated with a tag and recipient's publicly known unique identity, the recipient's private key.

### BRIEF DESCRIPTION OF THE DRAWINGS

Reference is now made to the following detailed description, taken in conjunction with the accompanying drawings. It is emphasized that various features may not be drawn to scale and dimensions of various features may be arbitrarily increased or reduced for clarity of discussion. Further, some components may be omitted in certain figures for clarity of discussion.

FIG. 1 is a block diagram illustrating a method for keys generation in accordance with some embodiments of the disclosure.

FIG. 2 is a block diagram illustrating a method for encrypting data using a public key in accordance with some embodiments of the disclosure.

FIG. 3 is a block diagram illustrating a method for decrypting encrypted data by the owner of the data in accordance with some embodiments of the disclosure.

FIG. 4 is a block diagram illustrating a method for access token generation by the owner of the data in accordance with some embodiments of the disclosure.

FIG. 5 is a block diagram illustrating a method for decrypting encrypted data by recipient in accordance with some embodiments of the disclosure.

FIG. 6 is a block diagram illustrating the comparison between commonly used method for one-to-one secret exchange and a method for data encipherment prior to key setup in accordance with some embodiments of the disclosure.

FIG. 7A is a block diagram illustrating the comparison between commonly used method for one-to-many secret exchange and a method for data encipherment prior to key setup for multiple recipients with some embodiments of the disclosure.

FIG. 7B is a block diagram illustrating the comparison between commonly used method for one-to-many secret exchange and a method for data encipherment prior to key setup for multiple recipients with some embodiments of the disclosure.

FIG. 8 is an exemplary system diagram in accordance with some embodiments of the disclosure in accordance with some embodiments of the disclosure.

FIG. 9A is an exemplary functional diagram in accordance with some embodiments of this disclosure.

FIG. 9B is an exemplary functional diagram in accordance with some embodiments of this disclosure.

FIG. 10 is a flow diagram illustrating a method for enciphering data prior to knowing a recipient according to a specific example embodiment of the disclosure.

Although similar reference numbers may be used to refer to similar elements for convenience, it can be appreciated what each of the various example implementations may be considered distinct variations.

### DETAILED DESCRIPTION

For the purposes of promoting an understanding of the principles of the invention, reference is made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some feature or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be reference to “advantages” provided by some embodiments of the present invention, other embodiments may not include those same advantages, or may include different advantages. Any advantages described herein are not to be construed as limiting to any of the claims.

Embodiments of the present disclosure generally include methods for encrypting data and delivering encrypted data. Embodiments include methods and systems for delivering encrypted data (e.g., e-mails, messages, files, binary strings and the like) to users (e.g. people, computers, tablet computers, cell phones, programs, software, and the like) or devices.

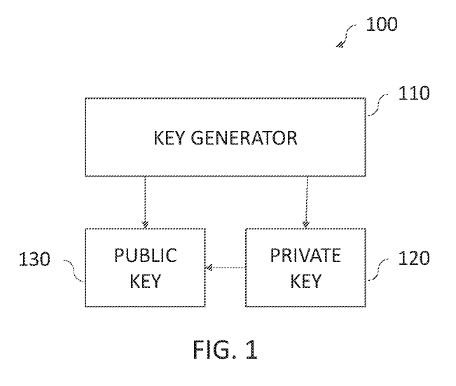

FIGS. 1-7 illustrates example embodiments. FIGS. 1-7 and the accompanying descriptions are provided by way of examples and comparisons only and not intended to be limiting.

FIG. 1 provides a diagram 100 illustrating a method for key generation. In some embodiments, cryptographic keys may be generated. A key owner, a device of the key owner, or a program or software on behalf of the key owner may generate the cryptographic keys randomly or from previously defined secret value. A public key is generated with well-defined mathematical properties from a private key. A private key may not be derived from a public key. A public key is used to encrypt a plain text into enciphered text, and a corresponding private key is used to decrypt the enciphered text into plain text.

As shown in FIG. 1, the key generation unit 110 (also referred to as key generator) may facilitate generation, analysis, and/or presentation of cryptographic keys associated with a user, a device, or a program or software. For example, the key generation unit 110 may generate a cryptographic key each time a user (e.g. the sender and/or the recipient) requests encryption of data. The private key 120 is generated randomly or recovered from previously defined secret value, and the public key 130 is generated using a mathematical relationship (e.g., a well-defined mathematical relationship) in association with the private key 120. The private key 120 should remain confidential in order to protect the secret for the owner of the keys. The public key 130 can be shared with any user, device, program, or software in order to facilitate secret sharing with the owner of the keys.

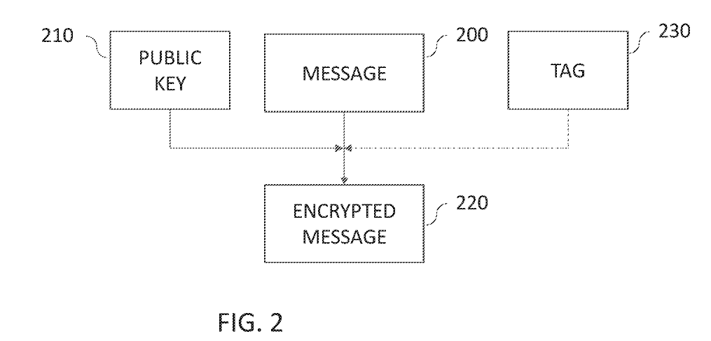

FIG. 2 provides a diagram illustrating a method for encrypting data using a public key and a tag. An entity can encrypt data using a public key. In some embodiments, an entity can be a user, device, program or software. In some embodiments, the entity may have a public key, such that data may be encrypted using the entity's public key. In some embodiments, a first entity may share secret with a second entity by using the second entity's public key to encrypt the data. In some embodiments, a first entity may share secret with a second entity by using the first entity's public key to encrypt the data. In some embodiments, the message 200 can be encrypted prior to deciding whether the message would be shared. In some embodiments, the encrypted message 220 can be shared as is with others without performing any data re-encryption specific to the sharing parties

As shown in FIG. 2, the message 200 is being encrypted with the public key 210 to generate the encrypted message 220. In some embodiments, encrypted message 220 can be decrypted with a private key. As such, any third party who has gained access to encrypted message 220 cannot recover the message 200 without a proper private key. In some embodiments, the encrypted message 220 can be shared as is prior to identifying the recipient by encrypting the message 200 with the entity's public key 210 and a non-secret tag 230.

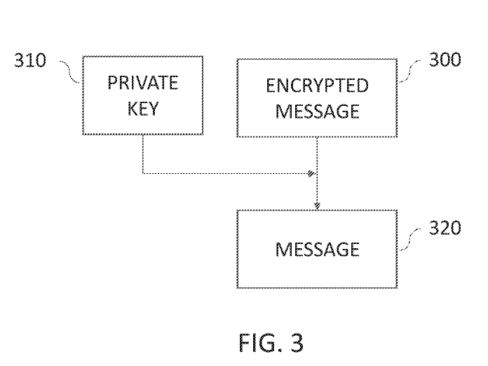

FIG. 3 provides a diagram illustrating a method for decrypting data using a private key 310. An entity can decrypt data using a private key. In some embodiments, an entity can be a user, device, program or software. In some embodiments, the entity may have a private key, such that enciphered data may be decrypted using the entity's private key. In some embodiments, a first entity may share secret with a second entity by decrypting the enciphered data using the second entity's private key provided that the encrypted message 300 is encrypted with a public key corresponding to the private key 310.

As shown in FIG. 3, the encrypted message 300 is being decrypted with the private key 310 to generate the message 320. In some embodiments, message 320 can be decrypted with the private key 310 from the encrypted message 300. In some embodiments, the encrypted message 300 can be encrypted with a public key. In some embodiments, the encrypted message 300 can be encrypted with a public key and a tag.

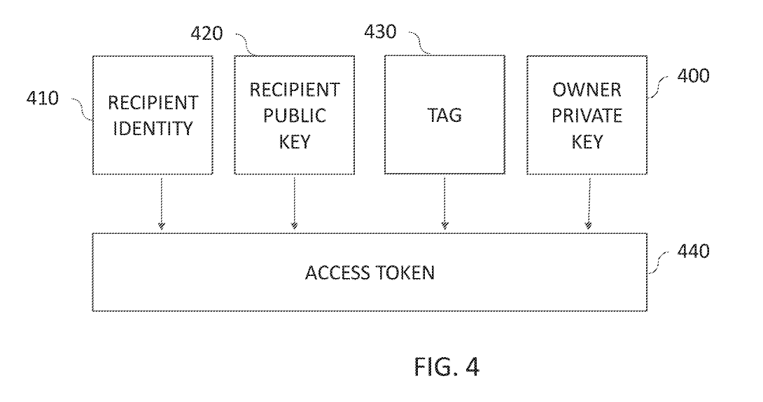

FIG. 4 provides a diagram illustrating a method for access token generation by the owner of the data in accordance with some embodiments of the disclosure. The owner private key 400, the recipient identity 410, the recipient's public key 420, and the tag 430 are used to generate the access token 440. In some embodiments, the private key 400 corresponds to a public key that is used to encrypt the data. In some embodiment, the recipient identity 410 can be any unique representation within a system. In some embodiments, the recipient identity 410 may be publicly known. In some embodiments, the recipient identity 410 may be known to one or a small group of entities. In some embodiments, an entity can be a user, device, program or software to improve the depth of defense. In some embodiments, the recipient public key 420 is generated by the recipient. In some embodiments, the tag 430 may be publicly known without compromising the security of the enciphered message. In some embodiments, an owner and recipients may keep the tag 430 secret among them in order to improve the depth of defense. In some embodiments, the tag 430 can be any non-zero-byte representation. In some embodiments, the tag 430 is used to segregate the security of data to share among a data owner and recipients. In some embodiments, the tag 430 can be a constant throughout the system. In some embodiments, the tag 430 can be a random number shared among owner and recipients. In some embodiments, a message that is encrypted with an owner's public key can be decrypted by a recipient's private key with the access token 440. In some embodiments, a public key, which is corresponded to the private key 400, is used to encrypt data. In some embodiments, the access token 440 can be generated after data is encrypted. In some embodiments, the access token 440 can be generated before any data sharing. In some embodiments, the access token 440 can be used to revoke the access of the shared data.

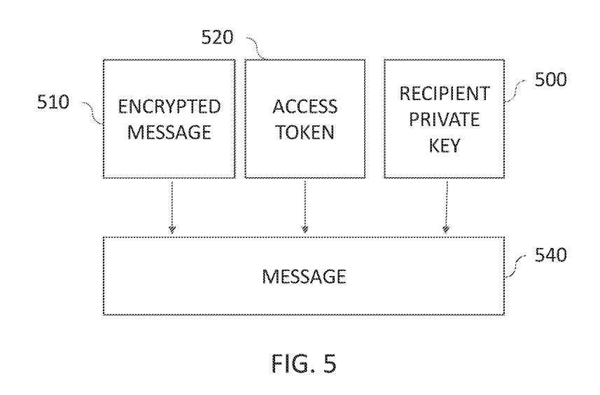

FIG. 5 is a diagram illustrating a method for decrypting encrypted data by recipient in accordance with some embodiments of the disclosure. A recipient can recover the message 540 by decrypting the encrypted message 510 using the recipient private key 500 and the access token 520. In some embodiments, the encrypted message 510 is enciphered with an owner's public key. In some embodiments, the encrypted message 510 is enciphered with a recipient's public key. In some embodiments, the access token 520 is generated by an owner's private key specifically for recipient. In some embodiments, the recipient can be a user, device, program or software.

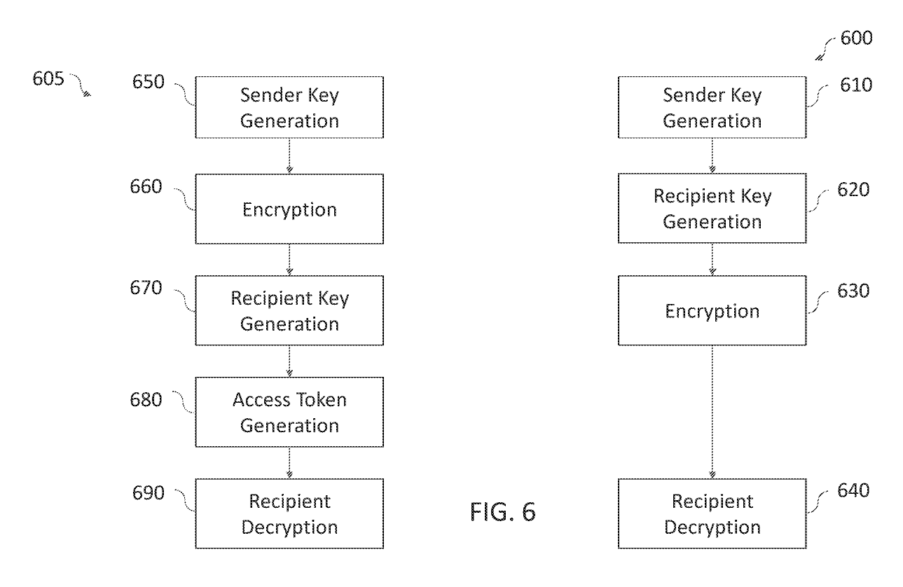

FIG. 6 is a diagram illustrating the comparison between commonly used method for one-to-one secret exchange and a method for data encipherment prior to key setup in accordance with some embodiments of the disclosure. Method 600 describes a commonly used method for one-to-one secret exchange using asymmetric, cryptographic keys. Prior to encrypting a message, a sender must obtain a recipient's public key in order for a sender to encrypt a message for a recipient using the recipient's public key. Hence, a recipient must perform key generation before secret exchange. Item 620 describes a recipient's key generation. A recipient would like to verify the authenticity of a secret message is originated from a sender using the sender's public key. Hence, a sender must perform key generation before a recipient decrypts the secret message. Item 610 describes a sender's key generation. A sender who wishes to share secret with a recipient would encrypt a message using a recipient's public key. Item 630 describes the encryption performed by a sender using a recipient's public key. A recipient can decrypt an enciphered message, which is encrypted with the recipient's public key, using a recipient's private key. Item 640 describes the decryption by a recipient using recipient's private key. Item 605 describes an improved method for one-to-one secret exchange using asymmetric, cryptographic keys prior to recipient selection. Item 650 describes a sender's key generation. A sender who wishes to share secret with any recipient may encrypt a message using the sender's public key prior to selecting the recipient. Item 660 describes the encryption performed by the sender using sender's public key. A recipient can perform key generation before or after a sender has encrypted a secret message. Item 670 describes recipient's key generation. When a sender decides to share a prior encrypted message with a recipient, the sender is not required to re-encrypt the message with any recipient's public key. A sender can send the encrypted message as is. An access token can be generated by the sender to enable recipient to decrypt the originally encrypted secret message. Item 680 describes access token generation by a sender. A recipient can recover the message from the encrypted message using the access token and a recipient's private key. Item 690 describes the recipient decryption.

As shown in FIG. 6, the comparison demonstrates couple of key advantages of the improved method 605 over commonly used method 600. First, commonly used method 600 requires recipient to be identified prior to data encryption, while improved method 605 can perform encryption without consideration of recipient. This allows a sender to protect secrecy and delay the decision of recipient's selection. Second, commonly used method 600 could require substantial computing effort to re-encrypt data when a recipient is identified, while improved method 605 does not require any data re-encryption. For a large amount of secret data to share, no computing effort is required, only generation of access token is sufficient to share secret without compromising security.

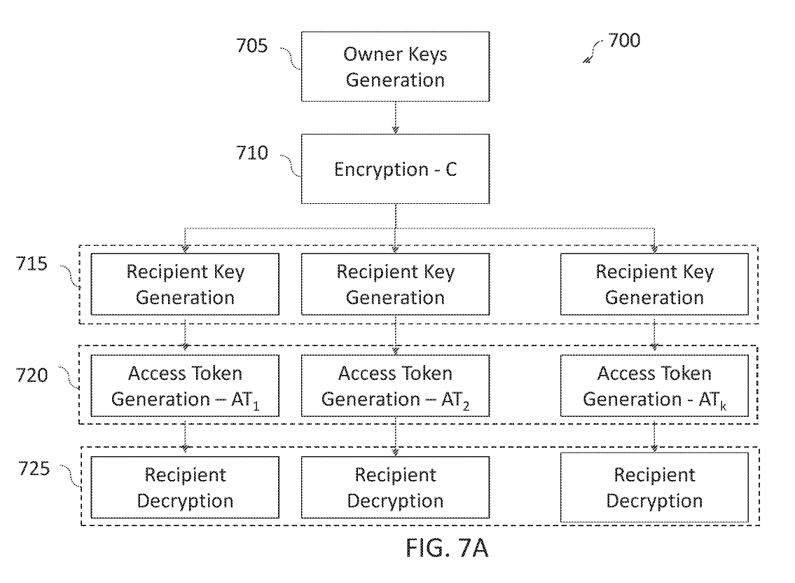

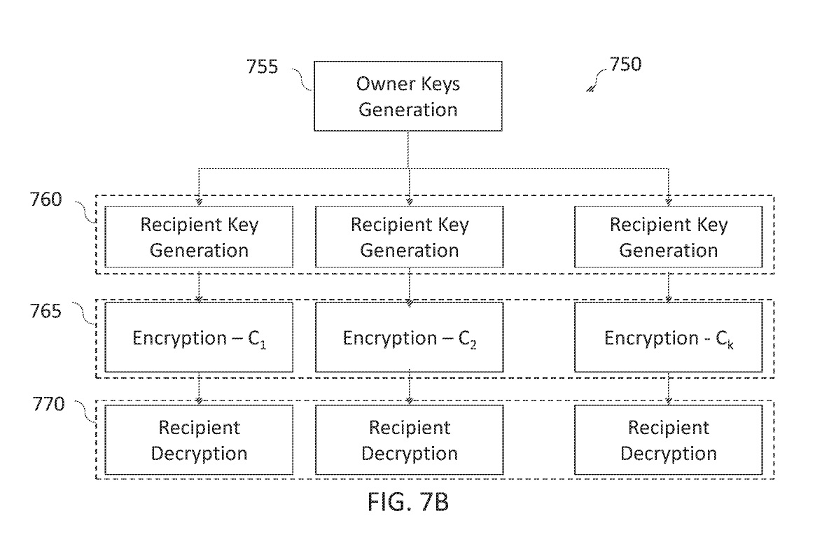

FIGS. 7A and 7B are diagram illustrating the comparison between commonly used method for one-to-many secret exchange and a method for data encipherment prior to key setup for multiple recipients with some embodiments of the disclosure. Item 750 describes a commonly used method for one-to-many secret exchange using asymmetric, cryptographic keys. Prior to encrypting a message, a sender must obtain all recipients' public keys in order for a sender to encrypt a message for each recipient using the recipients' public keys. Hence, all recipients must perform key generation before multiple recipient secret exchanges. Item 760 describes recipients' key generation. Each recipient must generate their respective keys. Item 755 describes a sender's key generation. A sender who wishes to share secret with a recipient would encrypt a message using a recipient's public key. Item 765 describes the encryption performed by a sender using recipients' public key. For the same message, a sender must encrypt multiple times for each recipient using respective public keys. Each recipient can decrypt respective enciphered message, which is encrypted with the recipient's public key, using the recipient's private key. Item 700 describes an improved method for one-to-many secret exchange using asymmetric, cryptographic keys prior to recipient selection. After the sender's key generation 705, encryption is performed with the sender's public key only once. Item 710 describes the encryption. Because encryption does not depend on the availability of recipient's keys, recipient key generation can be performed before or after the encryption 710. Item 715 describes the recipient key generation. A sender can send the encrypted message as is regardless of the number of recipients. An access token is generated for each recipient by the sender to enable each recipient to decrypt the originally encrypted secret message. Item 720 describes access token generation by a sender for each recipient. Each recipient can recover the message from the encrypted message using the corresponding access token and each recipient's private key. Item 725 describes decryption by respective recipients.

As shown in FIGS. 7A and 7B, the comparison demonstrates a key advantage of scalability prior to recipient selection for multiple recipients. Data encryption only needs to be performed once. If there is a large set of data, this translates to a huge saving of computing resources. Access token generation 720 is performed separately and independently of encrypted data and recipient. Each recipient can decrypt the same encrypted message with their private key and respective access token.

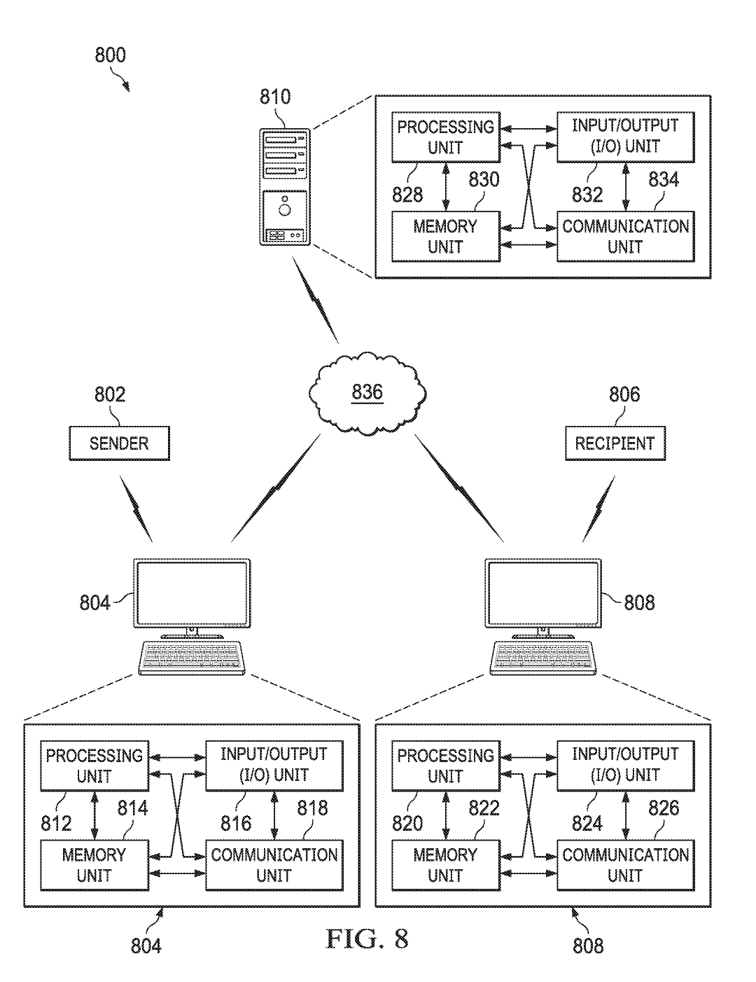

FIG. 8 illustrates a more detailed system for enabling between a sender 802 and the recipient 806 as described herein (e.g. as described in the illustrative examples of FIGS. 1-7). Although two users 802 and 806 are illustrated in the presently described embodiment, the concepts disclosed here may be similarly applicable to an embodiment that includes more than two users.

In some embodiments, the system 800 may include the sender, the recipient, and a server. In some embodiments, the sender 802 and the recipient 806 may each use a computing device 804, 808 which may include, but not be limited to, a smart phone, a tablet, a laptop computer, a desktop computer, a personal digital assistant (PDA), a smart watch, a wearable device, a biometric device, an implanted device, a camera, a video recorder, an audio recorder, a touchscreen, a computer server or communication server, and/or the like. In some embodiments, the sender's device 804 and/or the recipient's device 808 may each include a plurality of devices as described herein. In some embodiments, the sender's device 804 may include various elements of a computing environment as described herein. For example, the sender's device 804 may include a processing unit 812, a memory unit 814, an input/output (I/O) unit 816, and/or a communication unit 818. Each of the processing unit 812, the memory unit 814, the input/output (I/O) unit 816, and/or the communication unit 818 may include one or more subunits as described herein for performing operations associated with providing relevant contextual features to the sender 802 during delivery of encrypted data.

In some embodiments, the recipient's device 808 may include various elements of a computing environment as described herein. For example, the recipient's device 808 may include a processing unit 820, a memory unit 822, an input/output (I/O) unit 824, and/or a communication unit 826. Each of the processing unit 820, the memory unit 822, the input/output (I/O) unit 824, and/or the communication unit 826 may include one or more subunits as described herein for performing operations associated with providing relevant contextual features to the recipient during delivery of encrypted data.

In some embodiments, the server 810 may include a computing device such as a mainframe server, a content server, a communication server, a laptop computer, a desktop computer, a handheld computing device, a smart phone, a smart watch, a wearable device, a touch screen, a biometric device, a video processing device, an audio processing device, a cloud-based computing solution and/or service, and/or the like. In some embodiments, the server 810 may include a plurality of servers configured to communicate with one another and/or implement encryption techniques described herein.

In some embodiments, the server 810 may include various elements of a computing environment as described herein. For example, the server 810 may include a processing unit 828, a memory unit 830, an input/output (I/O) unit 832, and/or a communication unit 834. Each of the processing unit 828, the memory unit 830, the input/output (I/O) unit 832, and/or the communication unit 834 may include one or more subunits and/or other computing instances as described herein for performing operations associated with delivering encrypted data. In some embodiments, the memory unit 830 may not be present in the server 810.

The sender's device 804, the recipient's device 808, and/or the server 810 may be communicatively coupled to one another by a network 836 as described herein. In some embodiments, the network 836 may include a plurality of networks. In some embodiments, the network 836 may include any wireless and/or wired communications network that facilitates communication between the sender's device 804, the recipient's device 808, and/or the server 810. For example, the one or more networks may include an Ethernet network, a cellular network, a computer network, the Internet, a wireless fidelity (Wi-Fi) network, a light fidelity (Li-Fi) network, a Bluetooth network, a radio frequency identification (RFID) network, a near-field communication (NFC) network, a laser-based network, and/or the like.

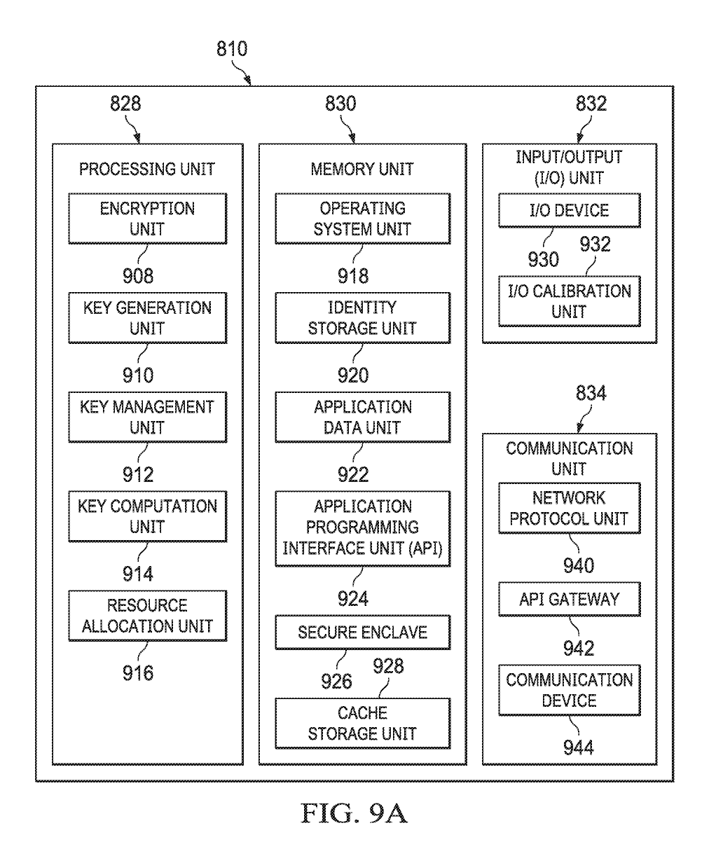

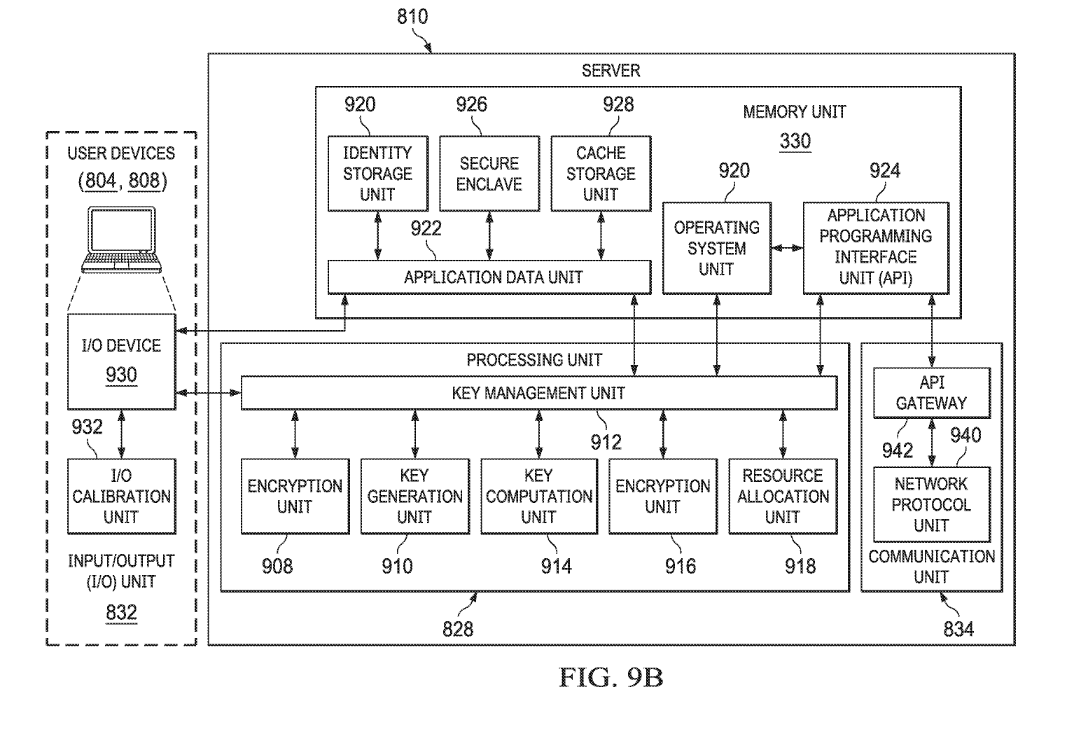

FIG. 9A and FIG. 9B illustrate exemplary functional and system diagrams for the server 810 for enabling delivery of encrypted data and associated encryption techniques described herein. Specifically, FIG. 9A provides a functional block diagram of the server 810, whereas FIG. 9B provides a detailed system diagram of the server 810. In addition, any units and/or submits described herein with reference to the server 810 of FIG. 9A and/or FIG. 9B may be included in one or more elements of FIG. 8 such as the sender (e.g., the processing unit 812, the optional memory unit 814, the I/O unit 816, and/or the communication unit 818), the recipient (e.g., the processing unit 820, the optional memory unit 822, the I/O unit 824, and/or the communication unit 826), and/or the server of FIG. 2, the key server of FIG. 3, and/or the server of FIG. 4-7 (e.g., the processing unit 828, the optional memory unit 830, the I/O unit 832, and/or the communication unit 834). However, the server 810 and the sender's device 804 may not be the same device, and the server 810 and the recipient's device 808 may not be the same device. The server 810 and/or any of its units and/or subunits described herein may include general hardware, specifically-purposed hardware, and/or software. Any of the units and/or sub-units illustrated and/or described herein are optional.

The server 810 may include, among other elements, a processing unit 828, an optional memory unit 830, an input/output (I/O) unit 832, and/or a communication unit 834. As described herein, each of the processing unit 828, the optional memory unit 830, the I/O unit 832, and/or the communication unit 834 may include and/or refer to a plurality of respected units, subunits, and/or elements. Furthermore, each of the processing unit 828, the memory unit 830, the I/O unit 832, and/or the communication unit 834 may be operatively and/or otherwise communicatively coupled with each other so as to facilitate the encryption and delivery technique described herein.

The processing unit 828 may control any of the one or more of the optional memory unit 830, the I/O unit 832, the communication unit 834, as well as any included subunits, elements, components, devices, and/or functions performed by the memory unit 830, the I/O unit 832, and the communication unit 834 included in the server 810. The described sub-elements of the server 810 may also be included in similar fashion in any of the other units and/or devices included in the system 800 of FIG. 8. Furthermore, any actions described herein as being performed by a processor may be taken by the processing unit 828 alone and/or by the processing unit 828 in conjunction with one or more additional processors, units, subunits, elements, components, devices, and/or the like. In addition, while only one processing unit 828 may be shown in FIG. 9A and/or FIG. 9B, multiple processing units may be present and/or otherwise included in the server 810 or elsewhere in the overall system (e.g. system 800 of FIG. 8). Thus, while instructions may be described as being executed by processing unit 828 (and/or various subunits of the processing unit 828), the instructions may be executed simultaneously, serially, and/or otherwise by one or multiple processing units.

In some embodiments, the processing unit 828 may be implemented as one or more computer processing unit (CPU) chips and may include a hardware device capable of executing computer instructions. The processing unit 828 may execute instructions, codes, computer programs, and/or scripts. The instructions, codes, computer programs, and/or scripts may be received from and/or stored in the optional memory unit 830, the I/O unit 832, the communication unit 834, subunits and/or elements of the aforementioned units, other devices and/or computing environments, and/or the like.

In some embodiments, the processing unit 828 may include, among other elements, subunits such as a key generation unit 910, a key management unit 912, a key computation unit 914, an encryption unit 908, and/or a resource allocation unit 916. Each of the aforementioned subunits of the processing unit 828 may be communicatively and/or operably coupled with each other.

The key generation unit 910 may facilitate generation, analysis, and/or presentation of cryptographic keys associated with a user. For example, the key generation unit 910 may generate a cryptographic key each time a user (e.g., the sender and/or the recipient) requests encryption of data. The key generation unit 910 may control and/or utilize an element of the I/O unit 832 to enable a user to request encryption and communicate progress of user requests.

The key management unit 912 may facilitate detection, analysis, transmission, and/or tracking of cryptographic keys. Cryptographic keys may include keys generated by the sender, keys generated by the recipients, keys generated by the key generation unit 910, and/or keys computed by the key computation unit 914. The key management unit 912 may receive cryptographic keys from users (e.g., the sender and the recipient), the key generation unit 910, and/or the key computation unit 914. The key management unit 912 may process, analyze, organize, and/or otherwise transfer any key received from users, the key generation unit 910, and/or the key computation unit 914. However, the key management unit 912 may not store cryptographic keys.

The key computation unit 914 may facilitate transformation of a cryptographic key. The key computation unit 914 may transform the representation of a cryptographic key using a mathematical function. A representation may include, but not be limited to, a mathematical value, a sequence of numbers and/or characters, a bit string, and any combination thereof. The key computation unit 914 may use inputs from users to transform a cryptographic key. Inputs from users may include an identity of a user, a private key of a user, a public key of a user, and/or the like. The key computation unit 914 may further use inputs from the key management unit 912 and/or the identity storage unit 920 to transform a cryptographic key. The key computation unit 914 may transmit transformed keys to the key management unit 912.

The encryption unit 908 may facilitate encrypting data using a cryptographic key. The encryption unit 908 may use cryptographic keys from the key generation unit 914, the key management unit 912, the key computation unit 914, and the keys transmitted from the users. The encryption unit 908 may perform a series of mathematical function to convert unencrypted data to encrypted form.

The resource allocation unit 916 may facilitate determination, monitoring, analysis, and/or allocation of computing resources throughout the server 810 and/or other computing environments. For example, the server 810 may facilitate a high volume of encryption and delivery of data between a large number of users. As such, computing resources of the server 810 utilized by the processing unit 828, the memory unit 830, the I/O unit 832, and/or the communication unit 834 (and/or any subunit of the aforementioned units) such as processing power, data storage space, network bandwidth, and/or the like may be in high demand at various times during operation. Accordingly, the resource allocation unit 916 may be configured to manage the allocation of various computing resources as they are required by particular units and/or subunits of the server 810 and/or other computing environments. In some embodiments, the resource allocation unit 824 may include sensors and/or other specially-purposed hardware for monitoring performance of each unit and/or subunit of the server 810, as well as hardware for responding to the computing resource needs of each unit and/or subunit. In some embodiments, the resource allocation unit 916 may utilize computing resources of a second computing environment separate and distinct from the server 810 to facilitate a desired operation.

For example, the resource allocation unit 916 may determine a number of simultaneous key generation/transformation/transfer and/or data encryption requests. The resource allocation unit 916 may then determine that the number of key generation/transformation/transfer and/or data encryption requests meets and/or exceeds a predetermined threshold value. Based on this determination, the resource allocation unit 916 may determine an amount of additional computing recourses (e.g., processing power, storage space of a particular non-transitory computer-readable memory medium, network bandwidth, and/or the like) required by the processing unit 828, the memory unit 830, the I/O unit 832, the communication unit 834, and/or any subunit of the aforementioned units for enabling safe and efficient operation of the server 810 while performing requested key generation/transformation/transfer and/or data encryption. The resource allocation unit 916 may then retrieve, transmit, control, allocate, and/or otherwise distribute determined amount(s) of computing resources to each element (e.g., unit and/or subunit) of the server 810 and/or other computing environment.

In some embodiments, factors affecting the allocation of computing resources by the resource allocation unit 916 may include the number of ongoing key generation/transformation/transfers and/or data encryptions, a duration of time during which computing resources are required by one or more elements of the server 810, and/or the like. In some embodiments, computing resources may be allocated to and/or distributed amongst a plurality of second computing environments included in the server 810 based on one or more factors mentioned above. In some embodiments, the allocation of computing resources of the resource allocation unit 916 may include the resource allocation unit 916 flipping a switch, adjusting processing power, adjusting memory size, partitioning a memory element, transmitting data, controlling one or more input and/or output devices, modifying various communication protocols, and/or the like.

In some embodiments, the optional memory unit 830 be utilized for storing, recalling, receiving, transmitting, and/or accessing various files and/or information during operation of the server 810. For example, the optional memory unit 830 may be utilized for storing user information, and the like. The optional memory unit 830 may include various types of data storage media such as solid state storage media, hard disk storage media, and/or the like. The optional memory unit 830 may include dedicated hardware elements such as hard drives and/or servers, as well as software elements such as cloud-based storage drives. For example, the optional memory unit 830 may include various subunits such as an operating system unit 918, an identity storage unit 910, an application data unit 922, an application programming interface (API) unit 924, a secure enclave 926, and/or a cache storage unit 928. In some embodiments, the optional memory unit 830 may not be present in server 810, yet the server can perform all the functions described herein.

The optional memory unit 830 and/or any of its subunits described herein may include random access memory (RAM), read only memory (ROM), and/or various forms of secondary storage. RAM may be used to store volatile data and/or to store instructions that may be executed by the processing unit 828. For example, the data stored may be a command, a current operating state of the server 810, an intended operating state of the server 810, and/or the like. As a further example, data stored in the memory unit 830 may include instructions related to various methods and/or functionalities described herein. ROM may be a non-volatile memory device that may have a smaller memory capacity than the memory capacity of a secondary storage. ROM may be used to store instructions and/or data that may be read during execution of computer instructions. In some embodiments, access to both RAM and ROM may be faster than access to secondary storage. Secondary storage may be comprised of one or more disk drives and/or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory unit 830 may include one or more databases for storing any data described herein. Additionally or alternatively, one or more secondary databases located remotely from the server 810 may be utilized and/or accessed by the optional memory unit 830.

The operating system unit 918 may facilitate deployment, storage, access, execution, and/or utilization of an operating system utilized by the server 810 and/or any other computing environment described herein (e.g., a user device such as devices 804, 808 of FIG. 8). In some embodiments, the operating system may include various hardware and/or software elements that serve as a structural framework for enabling the processing unit 828 to execute various operations described herein. The operating system unit 918 may further store various pieces of information and/or data associated with operation of the operating system and/or the server 810 as a whole, such as a status of computing resources (e.g., processing power, memory availability, resource utilization, and/or the like), runtime information, modules to direct execution of operations described herein, user permissions, security credentials, and/or the like.

The identity storage unit 920 may facilitate deployment, storage, access, analysis, and/or utilization of user identities by the server 810 and/or any other computing environment described herein (e.g., a user device). A user identity may include, but not limited to, an email-address, or a phone number, or an Internet Protocol address, or a physical address of a computing device, or any representation that is operable to uniquely identify a recipient. For example, the identity storage unit 920 may store one or more user identities transmitted during a user registration. The identity storage unit 920 may transmit user identities to the key computation unit 914. In some embodiments, the identity storage unit 920 may not be present in the memory unit 830.

The application data unit 922 may facilitate deployment, storage, access, execution, and/or utilization of an application utilized by the server 810 and/or any other computing environment described herein (e.g., a device 804, 808). For example, users may be required to download, access, and/or otherwise utilize a software application on a user device such as a laptop in order for various operations described herein to be performed. As such, the application data unit 922 may store any information and/or data associated with the application. Information included in the application data unit 922 may enable a user to execute various operations described herein. The application data unit 922 may further store various pieces of information and/or data associated with operation of the application and/or the server 810 as a whole, such as a status of computing resources (e.g., processing power, memory availability, resource utilization, and/or the like), runtime information, modules to direct execution of operations described herein, user permissions, security credentials, and/or the like.

The API unit 924 may facilitate deployment, storage, access, execution, and/or utilization of information associated with APIs of the server 810 and/or any other computing environment described herein (e.g., a user device). For example, the server 810 may include one or more APIs for enabling various devices, applications, and/or computing environments to communicate with each other and/or utilize the same data. Accordingly, the API unit 924 may include API databases containing information that may be accessed and/or utilized by applications and/or operating systems of other devices and/or computing environments. In some embodiments, each API database may be associated with a customized physical circuit included in the memory unit 830 and/or the API unit 924. Additionally, each API database may be public and/or private, and so authentication credentials may be required to access information in an API database.

The secure enclave 926 may facilitate secure storage of data. In some embodiments, the secure enclave 926 may include a partitioned portion of storage media included in the memory unit 830 that is protected by various security measures. For example, the secure enclave 926 may be hardware secured. In other embodiments, the secure enclave 926 may include one or more firewalls, encryption mechanisms, and/or other security-based protocols. Authentication credentials of a user may be required prior to providing the user access to data stored within the secure enclave 926.

The cache storage unit 928 may facilitate short-term deployment, storage, access, analysis, and/or utilization of data. For example, the cache storage unit 928 may be utilized for temporarily storing a cryptographic key immediately before and/or after transfer/transformation. In some embodiments, the cache storage unit 928 may serve as a short-term storage location for data so that the data stored in the cache storage unit 928 may be accessed quickly. In some embodiments, the cache storage unit 928 may include RAM and/or other storage media types that enable quick recall of stored data. The cache storage unit 928 may include a partitioned portion of storage media included in the memory unit 830.

The I/O unit 832 may include hardware and/or software elements for enabling the server 810 to receive, transmit, and/or present information. In some embodiments, the term information may be used interchangeably with data or signals such as non-transitory signals. For example, elements of the I/O unit 832 may be used to receive user input from a user via a user device, present an encryption and/or decryption result to the user, and/or the like. In this manner, the I/O unit 832 may enable the server 810 to interface with a human user. As described herein, the I/O unit 832 may include subunits such as an I/O device 930 and/or an I/O calibration unit 932.

The I/O device 930 may facilitate the receipt, transmission, processing, presentation, display, input, and/or output of information as a result of executed processes described herein. In some embodiments, the I/O device 930 may include a plurality of I/O devices. In some embodiments, the I/O device 930 may include one or more elements of a user device, a computing system, a server, and/or a similar device.

The I/O device 930 may include a variety of elements that enable a user to interface with the server 810. For example, the I/O device 930 may include a keyboard, a touchscreen, a button, a sensor, a biometric scanner, a laser, a microphone, a camera, and/or another element for receiving and/or collecting input from a user. Additionally and/or alternatively, the I/O device 930 may include a display, a screen, a sensor, a vibration mechanism, a light emitting diode (LED), a speaker, a radio frequency identification (RFID) scanner, and/or another element for presenting and/or otherwise outputting data to a user. In some embodiments, the I/O device 930 may communicate with one or more elements of the processing unit 828 and/or the memory unit 830 to execute operations described herein.

The I/O calibration unit 932 may facilitate the calibration of the I/O device 432. For example, the I/O calibration unit 932 may detect and/or determine one or more settings of the I/O device 930, and then adjust and/or modify settings so that the I/O device 930 may operate more efficiently.

The communication unit 834 may facilitate establishment, maintenance, monitoring, and/or termination of communications between the server 810 and other devices such as users (e.g., user devices 804, 808 of FIG. 8), other computing environments, third party server systems, and/or the like. The communication unit 834 may further enable communication between various elements (e.g., units and/or subunits) of the server 810. In some embodiments, the communication unit 834 may include a network protocol unit 940, an API gateway 942, and/or a communication device 944. The communication unit 834 may include hardware and/or software elements.

The network protocol unit 940 may facilitate establishment, maintenance, and/or termination of a communication connection between the server 810 and another device (e.g., user devices 804, 808 of FIG. 8) by way of a network. For example, the network protocol unit 940 may detect and/or define a communication protocol required by a particular network and/or network type. Communication protocols utilized by the network protocol unit 940 may include Wi-Fi protocols, Li-Fi protocols, cellular data network protocols, Bluetooth® protocols, WiMAX protocols, Ethernet protocols, powerline communication (PLC) protocols, and/or the like. In some embodiments, facilitation of communication between the server 810 and any other device, as well as any element internal to the server 810, may include transforming and/or translating data from being compatible with a first communication protocol to being compatible with a second communication protocol. In some embodiments, the network protocol unit 940 may determine and/or monitor an amount of data traffic to consequently determine which particular network protocol is to be used for establishing connections with users to transfer keys and/or performing other operations described herein.

The API gateway 942 may facilitate the enablement of other devices and/or computing environments to access the API unit 924 of the optional memory unit 830 of the server 810. For example, a user device may access the API unit 924 via the API gateway 942. In some embodiments, the API gateway 942 may be required to validate user credentials associated with a user of a user device prior to providing access to the API unit 924 to the user. The API gateway 924 may include instructions for enabling the server 810 to communicate with another device.

The communication device 944 may include a variety of hardware and/or software specifically purposed to enable communication between the server 810 and another device, as well as communication between elements of the server 810. In some embodiments, the communication device 944 may include one or more radio transceivers, chips, analog front end (AFE) units, antennas, processing units, memory, other logic, and/or other components to implement communication protocols (wired or wireless) and related functionality for facilitating communication between the server 810 and any other device. Additionally and/or alternatively, the communication device 944 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes. While FIG. 9A is described as being the constituents of a server, in alternate embodiments, it could represent constituents of the device 804 or the device 808.

FIG. 9B illustrates an exemplary operation of the server 810. To begin operation of embodiments described herein, a sender (e.g., the sender 802 of FIG. 8) may download an encryption application associated with operations described herein, to a user device (e.g., the sender's device 804 of FIG. 8). For example, the user may download the encryption application from an application store or a library of applications available for download via an online network. In some embodiments, downloading the application may include transmitting application data from the application data unit 922 of the server 810 to the user device (e.g., the user device 804 of FIG. 8) via the communication unit 834.

Upon download and installation of the encryption application on the user device (e.g., the sender's device 804 of FIG. 8), the sender (e.g., the sender 802 of FIG. 8) may select and open the encryption application. The encryption application may then prompt the sender via the user device to register the sender and/or the device of the sender. In some embodiments, the sender may request to generate one or more new keys to register with the server 810. In some embodiments, the sender may send the request to the server 810, and the key generation unit 910 may generate new keys. In other embodiments, the processing unit (e.g., the processing unit 812 of FIG. 8) of user device (e.g., the user device 804 of FIG. 8) may generate new keys for the user and transmit the new keys to the key management unit 912. In some embodiments, the newly generated keys may include a new public key and a new private key for the sender. In some embodiments, the new private key may be transformed into a variant of the private key by a key deviation function using the processing unit (e.g., the processing unit 812 of FIG. 8) of the user device (e.g., the user device 804 of FIG. 8). The variant of the private key may be transmitted to the key management unit 912. In some embodiments, a variant of a private key may be referred to as a private key.

During the registration, the server may collect the sender's identities in the identity storage unit 920. An identity may include, but not limited to, an email-address, or a phone number, or an Internet Protocol address, or a physical address of a computing device, or any representation that is operable to uniquely identify a user. In some embodiments, the sender may enter the sender's user identities (e.g., e-mail address and/or phone number) using the I/O unit 816 from the user device. In some embodiments, the communication unit 944 may automatically read the user identities (e.g., physical address of the user device and/or Internet Protocol address) from the user device. Collected user identities may be stored in the identity storage unit 920.

After registration is complete, the sender may create data (e.g., a data file, a database object, a binary string, an e-mail, a text message, a document, a word file, a picture, an audio file, a video file, and any combination thereof) using the user device (e.g., the sender's device 804 of FIG. 8). After creating data, the user may be prompted by the encryption application to encrypt the data. The user may utilize an I/O device associated with an I/O unit 816 to request encryption of the data. In some embodiments, the user device may receive the request and generate a content key from the key generation unit of the processing unit of the user device. A content key may be a new cryptographic key that may be used to encrypt and decrypt data. A new content key may be generated for each set of data. The user device may encrypt one or more sets of data separately with the content keys using the encryption unit of the processing unit. The user device may further encrypt the content keys using the user's public key. Simultaneously, the user device may associate a tag to the encrypted content keys.

After encrypting the data, the server 810 may wait for a recipient (e.g., the recipient 806 of FIG. 8) to register. The recipient may download and install the encryption application and register with the server 810 in a similar manner the sender registers as described above. The recipient may register before, simultaneously, or after the sender registers. The recipient's identities may be stored in the identity storage unit 920.

After the recipient registers, the encrypted content key (e.g., the content key encrypted by the sender's public key) may be transmitted to the key management unit 912 and may be transferred to the key computation unit 914. The key generation unit 910 may generate a re-encryption key using at least one of the sender's private key, the recipient's identity, the tag attached to the encrypted content key, and the recipient's public key. The encrypted content key may be transformed to a transformation key in the key computation unit 914 using the re-encryption key. The transformation key may be transmitted from the key computation unit 914 to the key management unit 912. The key management unit 912 may further transmit the transformation key to the communication unit 834 to make the transformation key available to the recipient.

In some embodiments, the recipient's computing device (e.g., the recipient's device 808 of FIG. 8) may perform the decryption process after receiving the transformation key from the server 810. The recipient may receive the encrypted data and the transformation key by using the encryption application to read the encrypted data and the transformation key into the user device (e.g., the recipient's device 808 of FIG. 8). The communication unit 816 may read the encrypted data and the transformation key into the user device (e.g., the recipient's device 808). The processing unit 820 may recover the content key from the transformation key using the recipient's private key. The processing unit 820 may further decrypt the data using the content key. The I/O unit 824 may display the decrypted data for the recipient.

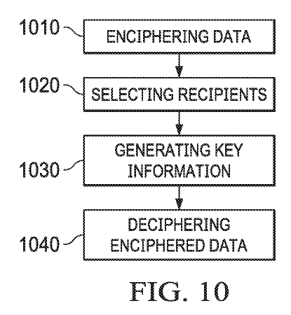

FIG. 10 provides a flow diagram illustrating a method for delivering enciphered data which may be enciphered prior to knowing a recipient according to a specific example embodiment of the disclosure.

When an initiating entity, which may be called a sender, delivers an enciphered data object to a receiving entity, which may be called a recipient, the current end-to-end encryption technology requires that: first, the recipient should already have a key generated and the sender should have a copy of the key of the recipient in advance; and second, the recipient's key should be known to the sender before the encryption can take place. However, these encryption systems may not work in instances where the recipient has not generated a key and the data has to be enciphered well before a recipient is known to the sender. Therefore, some embodiments of this disclosure are directed to a method for delivering encrypted data prior to knowing a recipient. In some embodiments, the sender may also be referred to as a data owner.

As shown in FIG. 10, in some embodiments, a method for delivering enciphered data may include an enciphering data process 1010. In some embodiments, a data owner may have a public key and a private key. In some embodiments, the data owner's public key may be used to encipher data. In some embodiments, the data owner's private key may be used to decipher enciphered data. According to some embodiments, an enciphering data process 1010 may include enciphering data with a data owner's public key. In some embodiments, a private key for deciphering data may be a data owner's private key. In other embodiments, a private key for deciphering data may be a recipient's private key. In some embodiments, the data owner may generate a symmetric key to encrypt data and encrypt the symmetric key with the data owner's public key. The enciphering data process 1010, in some embodiments, may not require prior knowledge of a recipient. Enciphering data without prior knowledge of a recipient may advantageously promote the ease of secure sharing by allowing the data owner to encrypt data at the data owner's convenience. Furthermore, enciphering data without prior knowledge of a recipient may advantageously promote efficient and secure use of resource and time by eliminating the need to wait for a recipient before encrypting data.

As shown in FIG. 10, the method for delivering enciphered data may include a choosing recipient process 1020. In some embodiments, the data owner may choose a recipient as the target recipient once the recipient has registered with a key server, which may be used to deliver keys to encrypt and decrypt data, and the recipient has generated a key. The data owner may have chosen a collection of recipients.

The key server may collect a unique identity of the recipient when the recipient registers with the key server. A unique identity may include one or multiple types of identification information. Identification information may include, but not limited to, an email address, a phone number, an Internet Protocol address, a physical or virtual address of a communication device, or any representations that can uniquely identify the recipient. Furthermore, in some embodiments, the recipient may generate a public key during registration of the recipient. The recipient may authenticate his or her legitimacy of possessing the unique identity before the key server would complete the registration. After registering with the key server, the recipient may readily decrypt the encrypted data. In some embodiments, the encrypted data may have been enciphered well before the recipient registers with the key server or the sender selects the recipient. According to some embodiments, a collection of recipients may be modified after the data has been enciphered and/or after the encrypted data has been delivered to the collection of recipients. Modifying a collection of recipients, in some embodiments, may not require a modification of enciphered data. In some embodiments, modifying a collection of recipient may not require re-encryption of the data.

In order to securely share data with the collection of recipients, in some embodiments, the data owner may send enciphered data to the collection of recipients directly. In other embodiment, the data owner may send enciphered data to a server, which acts as an intermediary between the sender and the recipient. In some embodiments, the server may be a cloud server. In some embodiments, the recipient may receive enciphered data, either directly from the sender or from the data server.

As shown in FIG. 10, according to some embodiments, a method for delivering enciphered data may include a generating key information process 1030. According to some embodiments, a generating key information process 1030 may include the data owner generating an access token. In some embodiments, an access token may be a key used to encipher another key or data. In some embodiments, an access token may be generated using at least one of the data owner's private key, the recipient's unique identity, and the recipient's public key. The access token may be transferred from the sender to the recipient through the key server or a trusted third party.

According to some embodiments, the data owner and/or the key server may not store any key and/or data. In some embodiments, the data owner and/or the key server may not use any memory to save keys used to encipher data. In some embodiments, no memory may be used to save recipient and tag specific information at the data owner's device (and/or the key server in some embodiments). In some embodiments, recipient and tag specific information may include a recipient's identity.

As shown in FIG. 10, according to some embodiments, a method for delivering enciphered data may include a deciphering enciphered data process 1040. In some embodiments, the deciphering enciphered data process 1040 may include the recipient deciphering data. According to some embodiments, during the deciphering enciphered data process 1040, the recipient may decipher the data using at least one of the access token and the recipient's private key.

According to some embodiments, enciphered data from an enciphering data process 1010 may only be deciphered by a data owner. In other embodiments, enciphered data from an enciphering data process 1010 may be deciphered only by the data owner and the collection of recipients authorized by the data owner.

Some specific example embodiments of the disclosure are illustrated by one or more of the examples provided herein.

### Example 1: Delivering Enciphered Data Contents Prior Key Setup

Given a data owner U who has a key information denoted by KeyU and a secret key information denoted by SKeyU. Given a collection of data denoted by M, and given a collection of recipients {R1, R2, . . . , Rk} for some integer k. Each of the recipients has a unique identity Ri is denoted by IDRi. The unique identity could be an email address. There is no other information regarding each of the recipients available.

The data owner U encrypts data collection M into an encrypted data denoted by C using the following inputs and only the following inputs: the data collection M, and U's key KeyU. No information of the recipients is required in the encryption including the identities of the recipients.

After C is created, no one but the data owner can decrypt C back to M. C can be decrypted back to M only if the data owner U's secret key SKeyU is given.

After C is created, the data owner U can further specify an arbitrary number of additional recipients denoted by R1′, R2′, . . . , Rk′ for some integer k. No further computation on the encrypted data C is required.

After C is created and a recipient, for example, Ri, has been specified by the data owner U, Ri generates a key information denoted by KeyRi and a secret information denoted by SKeyRi.

After generating the key KeyRi and secret key SKeyRi by the recipient Ri, the data owner U generates an access token denoted by ATi using the following inputs: U's secret key SKeyU, the recipient Ri's identity IDRi, and the recipient Ri's key KeyRi. The data owner U is stateless, no memory is required for U to memorize any encryption parameters from M to C, and no memory is required for U to keep track of any recipient-specific information including the identities of the recipients.

After receiving the access token ATi, the recipient Ri recovers the data collection M from the encrypted data C using the following inputs and only the following inputs: the encrypted data C, the access token ATi, and the recipient Ri's secret key SKeyRi.

In the above-described example, there is no entity including possibly some third-party servers or computing devices can decrypt C back to the data collection M.

Any transmission, reception, connection, or communication described in this disclosure may occur using any short-range (e.g., Bluetooth, Bluetooth Low Energy, near field communication, Wi-Fi Direct, etc.) or long-range communication mechanism (e.g., Wi-Fi, cellular, etc.). Additionally or alternatively, any transmission, reception, connection, or communication may occur using wired technologies. Any transmission, reception, or communication may occur directly between systems or indirectly via one or more systems.

The term signal, signals, data, or information may refer to a single signal or multiple signals. Any reference to a signal may be a reference to an attribute of the signal, and any reference to a signal attribute may refer to a signal associated with the signal attribute. As used herein, the term “real-time” or “dynamically” in any context may refer to any of current, immediately after, simultaneously as, substantially simultaneously as, a few microseconds after, a few milliseconds after, a few seconds after, a few minutes after, a few hours after, a few days after, a period of time after, etc. In some embodiments, the term “modify” or “modification” may be interchangeably used with the term “transform” or “transformation.”

The present disclosure provides several important technical advantages that will be readily apparent to one skilled in the art from the figures, descriptions, and claims. Moreover, while specific advantages have been enumerated above, various embodiments may include all, some, or none of the enumerated advantages. Any sentence or statement in this disclosure may be associated with one or more embodiments. Reference numerals are provided in the specification for the first instance of an element that is numbered in the figures. In some embodiments, the reference numerals for the first instance of the element are also applicable to subsequent instances of the element in the specification even though reference numerals may not be provided for the subsequent instances of the element.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A method for enciphering data, comprising:
determining, at a first computing device, key information;
enciphering, at the first computing device, data using the key information; and
selecting, at the first computing device, a recipient after enciphering the data.

2. The method of claim 1, wherein the data is enciphered at the first computing device and transmitted to the recipient before the recipient generates second key information.

3. The method of claim 1, wherein the enciphered data is decipherable using secret key information known only to the first computing device or a user of the first computing device.

4. The method of claim 2, wherein the recipient does not have second key information generated at the time of selection of the recipient at the first computing device, and wherein the first computing device requires unique identity information for selecting the recipient, wherein the identity information associated with the recipient is selected from a group consisting of an email address, a phone number, an Internet Protocol address, a social media address, a physical address of a computing device associated with the recipient, a virtual address of the computing device associated with the recipient, and any combination thereof.

5. The method of claim 1, wherein the enciphered data is decipherable at a second computing device associated with the recipient using secret key information associated with the second computing device.

6. The method of claim 1, wherein the enciphered data is decipherable at the second computing device further using an access token received from the first computing device.

7. The method of claim 6, wherein the access token is generated at the first computing device using at least one of identity information associated with the recipient, the key information, and second key information associated with the second computing device.

8. The method of claim 7, wherein the identity information associated with the recipient is uniquely selected from a group consisting of an email address, a phone number, an Internet Protocol address, a social media address, a physical address of a computing device associated with the recipient, a virtual address of the computing device associated with the recipient, and any combination thereof.

9. The method of claim 7, wherein the access token is unique to each recipient and cannot be used alone to decrypt the enciphered data.

10. The method of claim 1, wherein the first computing device does not store the key information.

11. The method of claim 1, wherein the first computing device does not store identification information associated with the recipient.

12. The method of claim 1, wherein the data is selected from a group consisting of a data file, a database object, a binary string, and any combination thereof.

13. The method of claim 1, wherein the recipient is associated with a second computing device, wherein the second computing device generates second key information after selection of the recipient at the first computing device.

14. The method of claim 13, wherein the second computing device decrypts the enciphered data using the second key information.

15. The method of claim 1, wherein no other computing device, other than the first computing device, can select the recipient for decrypting the enciphered data.

16. The method of claim 1, wherein the key information comprises a ciphered key embedded into the enciphered data.

17. A system for enciphering data, the system comprising a computing device processor configured for:
determining, at a first computing device, key information;
enciphering, at the first computing device, data using the key information; and
selecting, at the first computing device, a recipient after enciphering the data.

18. A non-transitory computer-readable medium for enciphering data, the non-transitory computer-readable medium comprising computer-executable code configured for:
determining, at a first computing device, key information;
enciphering, at the first computing device, data using the key information; and
selecting, at the first computing device, a recipient after enciphering the data.
